(19) United States
(12) Patent Application Publication
(10) Pub. No.: US 2026/0266391 A1
(43) Pub. Date: Sep. 10, 2026

(54) VALVE UPPER PART FOR SANITARY FITTINGS

(71) Applicant: Flühs Drehtechnik GmbH, Lüdenscheid (DE)

(72) Inventor: Tim-Florian KLAWIN, Halver (DE)

(73) Assignee: Flühs Drehtechnik GmbH, Lüdenscheid (DE)

(21) Appl. No.: 19/163,445

(22) PCT Filed: Feb. 8, 2024
(86) PCT No.: PCT/EP2024/053241

§ 371 Date: Sep. 9, 2025

(30) Foreign Application Priority Data
Mar. 10, 2023 (EP) 23161224.3

(51) Int. Cl. F16K 35/04; E03C 1/04; F16K 11/072; G05D 23/13

(52) U.S. Cl. CPC F16K 35/04; E03C 1/04; F16K 11/072; G05D 23/1313

(57) ABSTRACT

A valve upper part for a sanitary fitting, in particular a shower or tub fitting, has a head piece which is penetrated by a spindle which is arranged in the head piece in a rotatable but axially fixed manner and is connected to the valve element which can be controlled via the spindle. A device for limiting, in a surmountable manner, the maximum rotational angle of the spindle includes at least one spring-mounted blocking element which, when the spindle is in a defined angular position, engages in a recess arranged in the spindle or in the head piece.

The invention relates to an upper valve part, in particular a thermostat mixing valve, for a sanitary fitting, in particular a shower fitting or tub fitting, in accordance with the preamble of claim 1.

In shower fittings as well as tub fittings that can be thermostatically regulated, thermostat mixing valves are regularly used, by way of which the desired water temperature can be set. Such a thermostat mixing valve is described, for example, in EP 3 420 430 A1. In the case of these fittings, a flow valve is furthermore present, by way of which valve the amount of water can be set by the user. Such a flow valve is described, for example, in DE 20 2005 003 127 U1 . Such fittings have a cold-water inflow and a hot-water inflow. The two inflows open into a mixing chamber of the thermostat mixing valve, which chamber is connected to the outflow of the fitting. In the region of the mixing chamber, a thermal element is provided, which regulates the temperature set by the user. The thermal element is capable of reacting to temperature variations of the mixed water and either throttling or releasing the cold-water inflow or hot-water inflow as a function of that, so that the temperature desired by the user remains approximately constant.

The thermostat valve can be operated by way of a spindle that is mounted so as to rotate, which spindle is provided with a temperature selection handle. In order to prevent scalding when water is extracted, this temperature selection handle has a locking button that is regularly set at 38° C. and limits the maximum rotation of the spindle of the thermostat valve. Setting of the limit temperature takes place by means of positioning of the temperature selection handle on the spindle of the thermostat mixing valve. A higher temperature can be set only after the locking device has been overcome by means of pressing down on the locking button, so that the spindle can be rotated further.

The previously known lock integrated into the temperature selection handle, also called scald protection, is complicated to produce and furthermore impairs the esthetic overall appearance of a fitting.

This is where the present invention takes its start. The invention is based on the task of making available an upper valve part that allows simplified scald protection that specifically does not impair the esthetics of a fitting. According to the invention, this task is accomplished by means of an upper valve part having the characteristics of claim 1.

With the invention, an upper valve part is made available, which allows simplified scald protection that specifically does not impair the esthetics of a fitting. Because of the fact that the means for limiting the maximum rotation angle of the spindle in a surmountable manner comprise at least one locking element that is spring-mounted, which element engages into a recess arranged in the spindle or in the head piece in a defined rotational position of the spindle, rotational inhibition integrated into the upper valve part, at a specific rotational position, and thereby at a specific limit temperature is made possible. No further measures in the case of the rotating handle to be applied to the spindle for operation are necessary. The rotational inhibition can be overcome by means of a significant increase in the torque, so that an—intentional—further increase in the water temperature is made possible.

In a further development of the invention, an annular spring is provided, enclosing the spindle, by way of which spring the at least one locking element is resiliently mounted so as to be pre-stressed against the spindle, wherein the spindle has at least one recess for engagement of a locking element in a specific rotational position. In this way, minimization of the required construction space is achieved.

In an embodiment of the invention, the at least one locking element is formed by means of a cylindrical body that is preferably mounted so as to rotate. In this way, a significant resistance to rotation is made possible when the cylindrical body engages into a recess, as compared to a spherical locking body, which can certainly also be used. It is advantageous if the at least one recess is a notch introduced into the spindle.

In a further embodiment of the invention, the at least one locking element is guided in a cylindrical holder through which the spindle passes so as to rotate, and which holder is enclosed by the annular spring, wherein locking means are provided, by way of which means the cylindrical holder can be fixed in place in a desired rotational position. In this way, setting of the desired position of the locking bodies in the head piece, and thereby of the rotational position of the spindle, in which position engagement of the at least one locking element into a recess takes place, with subsequent locking in place of this selected position of the annular body in which the locking bodies are guided, is made possible. In this way, setting of the limit temperature with subsequent fixation of this limit temperature is achieved.

In a further embodiment of the invention, the locking means can be operated from the end face of the head piece. In this way, accessibility of the locking means in the installed state of the upper valve part is guaranteed.

In a further development of the invention, the locking means comprise a holding ring that is connected to the cylindrical holder in a torque-proof manner. By way of this holding ring, fixation of the cylindrical holder in the desired rotational position is made possible. Preferably, the cylindrical holder has a non-round outside contour that engages into a corresponding non-round inside contour of the holding ring and is connected to this contour with shape fit.

In an embodiment of the invention, the locking means comprise engagement means that surround the head piece, by way of which the holding ring can be fixed in place. In this way, it is made possible to lock the cylindrical holder in place in its rotational position, by way of the holding ring.

In a further embodiment of the invention, the engagement means comprise an engagement ridge that is present on the head piece and runs around it, at least in certain regions, as well as an engagement projection that is present on the holding ring and runs around it radially, at least in certain regions, wherein the screw means are preferably formed by at least one screw introduced into a threaded bore of the holding ring, which screw can be braced against the head piece at a right angle to the engagement ridge. By means of tightening the at least one screw, easy bracing of the holding ring against the engagement groove is made possible, and thereby the holding ring is connected to the head piece in a torque-proof manner. In this way, the cylindrical holder is held by the holding ring in a torque-proof manner.

In a further development of the invention, the locking means comprise an inside thread, by way of which the holding ring can be screwed onto an outside thread that is present on the head piece, wherein a fixation ring that lies against the holding ring lies on a ledge that is arranged in the head piece. By means of simple tightening of the screw connection between the holding ring and the head piece, the fixation ring can be pressed against the ledge, and thereby this ring is fixed in place in its rotational position, with force fit.

In an embodiment of the invention, the spindle is provided with a gear mechanism, radially on its circumference, which mechanism is interrupted by the at least one recess. In this way, haptically appealing turning of the spindle is achieved.

In one embodiment, the upper valve part is configured as a thermostat mixing valve. In this regard, the valve element is a setting element that can be displaced by means of turning the spindle axially, by means of which element it is made possible to set the desired temperature, at first up to a limit temperature, for example 38 degrees Celsius. At this rotational position, the at least one locking element engages into a recess of the spindle. By means of a significant increase in the torque, this locking position can be overcome, and afterward higher temperatures can be set.

In a further embodiment, the upper valve part is configured as a flow valve, wherein the valve element is preferably a control disk that can be rotated by way of the spindle, relative to an inlet disk that is arranged fixed in place. In this embodiment, the radial positioning of the locking elements, which are pre-stressed by a spring, serves for setting a preferred water volume stream, for example 50 percent of the maximum volume stream. After this locking position has intentionally been overcome, once again by means of a significant increase in the torque, an increase in the water volume stream is then possible.

Other further developments and embodiments of the invention are indicated in the remaining dependent claims. Exemplary embodiments are shown in the drawings and will be described in detail below. The figures show:

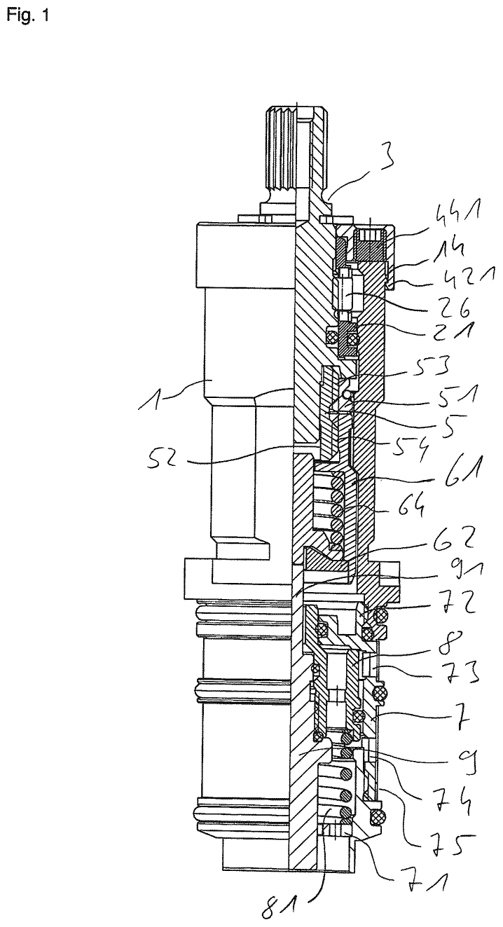

FIG. 1: the schematic representation of a thermostat mixing valve;

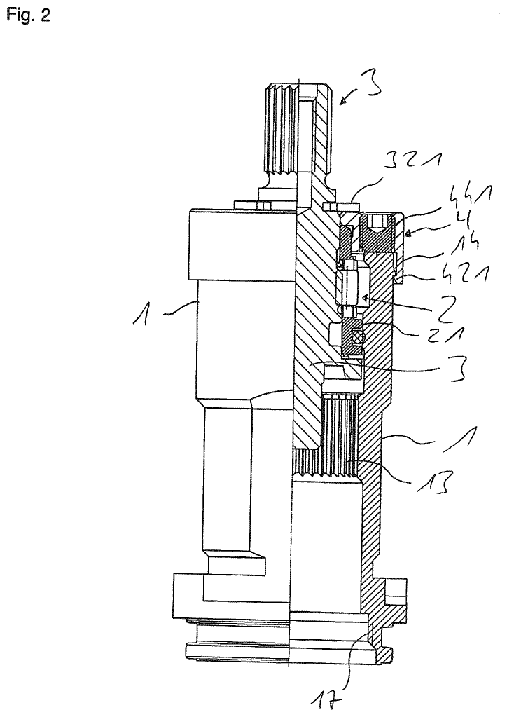

FIG. 2: the components of the scald protection of the thermostat mixing valve from FIG. 1;

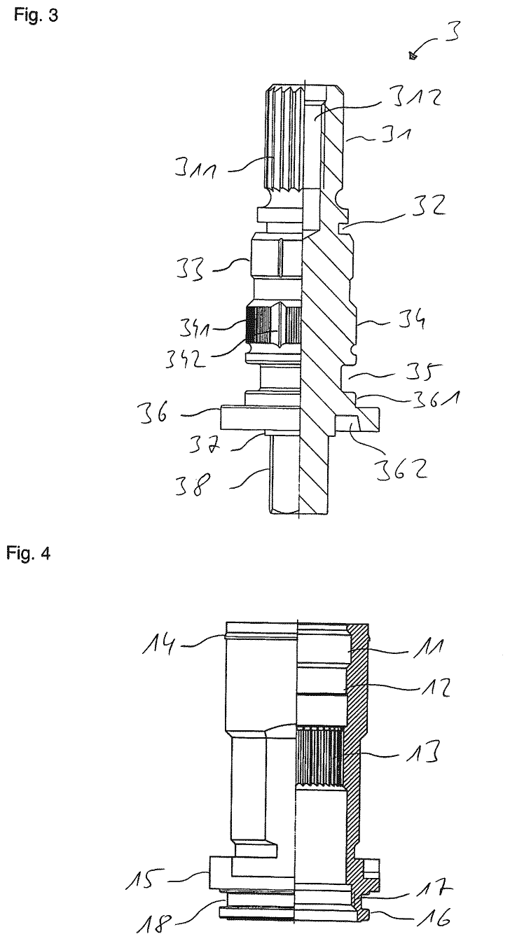

FIG. 3: the representation of the spindle of the thermostat mixing valve from FIG. 1, in partial section;

FIG. 4: the representation of the head piece of the thermostat mixing valve from FIG. 1, in partial section;

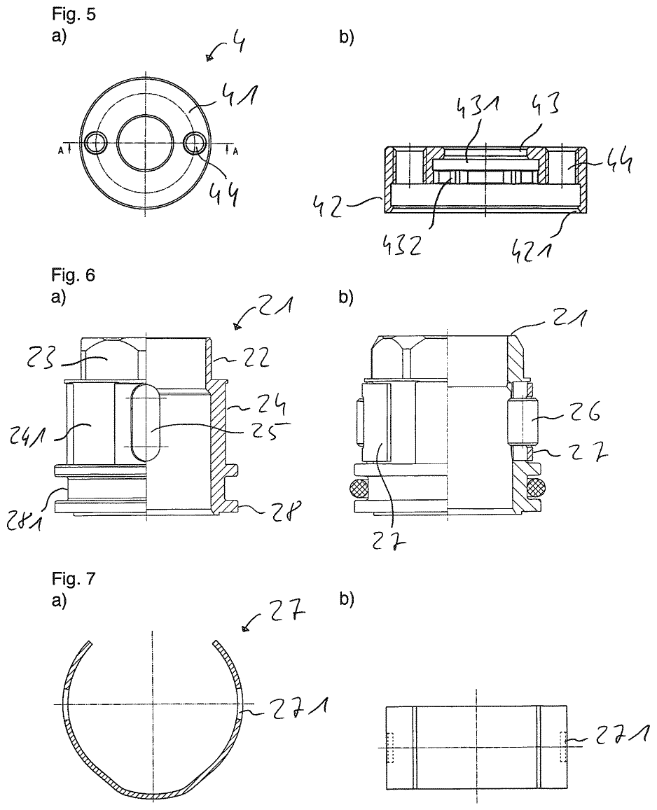

FIG. 5: the representation of the holding ring of the thermostat mixing valve from FIG. 1
a) in a top view;
b) in longitudinal section;

FIG. 6: the representation of the cylindrical holder of the spindle guide of the thermostat mixing valve from FIG. 1
a) in partial section;
b) in partial section, with cylindrical body and annular spring;

FIG. 7: the representation of the spring ring of the spindle guide of the thermostat mixing valve from FIG. 1
a) in longitudinal section;
b) in a side view;

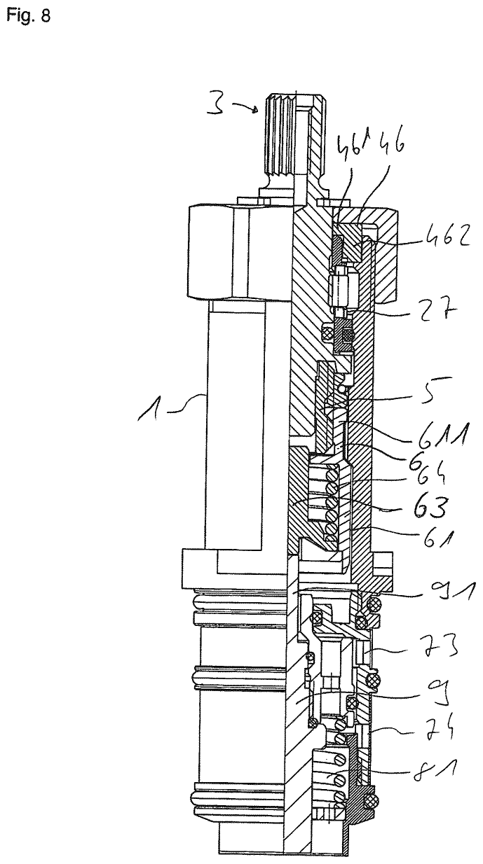

FIG. 8: the schematic representation of a thermostat mixing valve in a second embodiment;

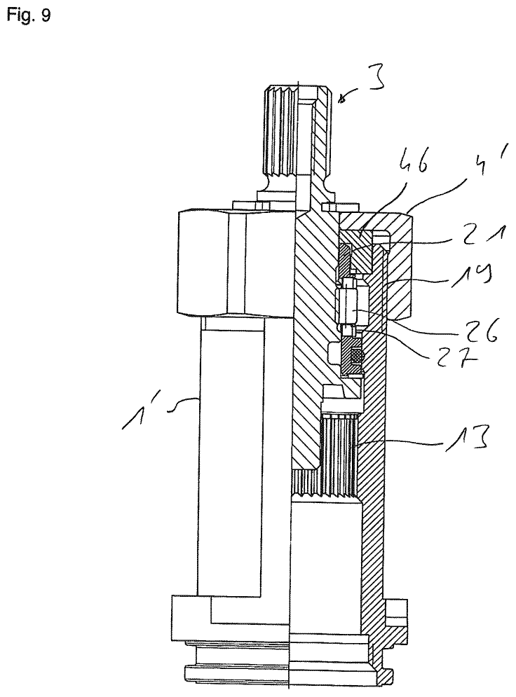

FIG. 9: the components of the scald protection of the thermostat mixing valve from FIG. 8;

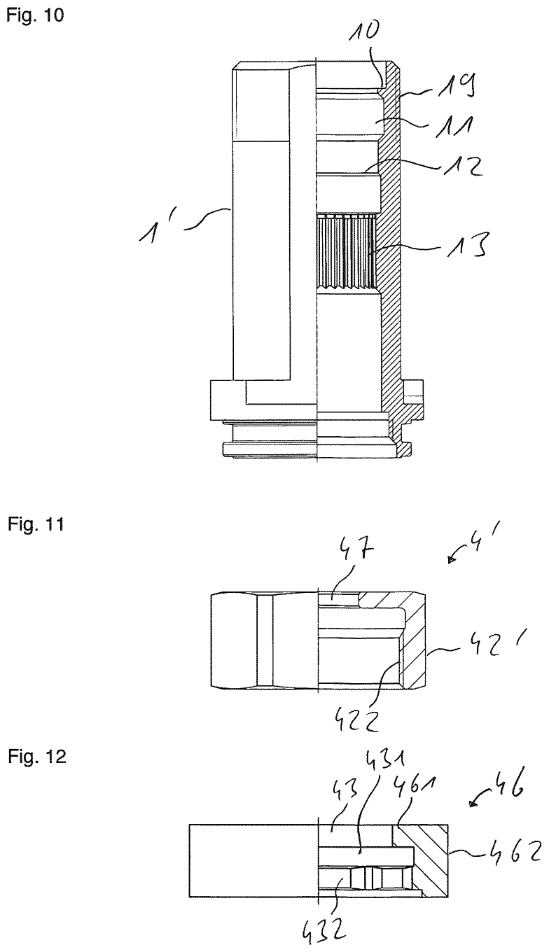

FIG. 10: the representation of the head piece of the thermostat mixing valve from FIG. 8, in partial section;

FIG. 11: the representation of the holding ring of the thermostat mixing valve from FIG. 8, in partial section, and
FIG. 12: the representation of the fixation ring of the thermostat mixing valve from FIG. 8, in partial section.

The thermostat mixing valve selected as an exemplary embodiment according to FIG. 1 has a head piece 1 that holds a spindle guide 2 on an end side, in which guide a spindle 3 is guided so as to rotate and radially, and which guide is connected, in a torque-proof manner, to a holding ring 4, which ring is arranged on the head piece 1 on the end side. The spindle 3 is connected, in a torque-proof manner, to a threaded sleeve 5, which is arranged in the head piece 1, by way of a pressure piece 51, so as to be axially movable. The pressure piece 51 stands in connection with a cone 6 that is axially guided in the head piece 1. On its end that faces away from the spindle 3, the head piece 1 is screwed into a passage sleeve 7, in which a carriage 8 is arranged so as to move, which carriage is connected to a thermal element 9. At its end that lies opposite the spindle 3, a bottom piece 71 is screwed into the passage sleeve 7.

The head piece 1 consists of a symmetrical hollow body, the two end face surfaces of which are open. In the region of the spindle 3, a groove 11 is introduced into the head piece 1, which groove is followed by a stepped, hollow-cylindrical section 12 that is delimited by a subsequently arranged inside polygon section 13. The inside polygon section 13 prevents a rotation of the pressure piece 51 as well as of the cone 6 within the head piece 1. At the level of the groove 11, an engagement ridge 14 is arranged on the head piece 1, circumferentially on the outside. At its end that faces away from the spindle 3, a contact flange 15 is arranged on the head piece 1, which flange is followed by an axial collar 16 that is provided with an inside thread 17. At the level of the inside thread 17, an annular groove 18 for holding an O-ring is provided circumferentially on the outside.

The spindle guide 2 comprises a cylindrical holder 21 that is configured as an essentially symmetrical hollow body, the two end faces of which are open. At its end that faces the connection section 31 of the spindle 3, the cylindrical holder 21 has a guide section 22 that is configured to be cylindrical on the inside and as an outside hexagon 23 on the outside. The guide section 22 is followed by a diameter-increased section 24, which section is provided, circumferentially on the outside, with flattened areas 241 that are spaced apart from one another, and into which section two diametrically opposite elongated hole bores 25 that extend axially are introduced, which bores each hold a cylindrical body 26. An annular spring 27 is applied to the guide section 22, spanning the cylindrical bodies 26, which spring has two rectangular gaps 271, the width of which is less, in each instance, than the diameter of the cylindrical body 26 that passes through them, in each instance, in certain regions. The diameter-widened section 24 is delimited, on the end side, by a ledge 28 into which an annular groove 281 for holding an O-ring is introduced circumferentially.

The spindle 3 has a connection piece 31 at its one end, which piece is structured as a polygon 311 on the outside and provided with a dead-end hole 312 having an inside thread on the inside. The connection piece 31 serves to hold a rotating handle or lever—not shown. At a distance from the connection piece 31, a puncture 32 for holding a securing ring 321 is introduced into the spindle 3, which puncture is followed by a cylindrical section 33. Axially at a distance from the cylindrical section 33, the spindle 3 has a contact section 34 that is provided with a gear mechanism 341 circumferentially. Within the region of the contact section 34 provided with the gear mechanism 341, two notches 342 that extend axially and lie diametrically opposite one another are introduced into the section, for engagement of a cylindrical body, in each instance. At a distance from the contact section 34, a groove 35 is provided, followed by a circumferential spindle rim 36, which has a circumferential step 361 by which the groove 35 is delimited. On its underside, which lies opposite the step 361, a ring-shaped depression 362 is introduced into the spindle rim 36. Subsequent to the spindle rim 36, a ledge 37 is provided, followed by an outside polygon 38 that is configured as an outside hexagon in the present case.

The holding ring 4 comprises a disk 41, on which a ring-shaped flange 42 is arranged circumferentially on the outside, the outside diameter of which flange corresponds to the outside diameter of the disk 41. On its free end, the flange 42 has an engagement projection 421 circumferentially on the inside. An axial step bore 43 is introduced into the disk 41, centrally, the diameter-widened section 431 of which bore, which section faces the flange 42, is provided circumferentially with indentations 432 for holding the outside hexagon 23 of the guide section 22 of the cylindrical holder 21. At a distance from the step bore 43, two threaded bores 44 are introduced into the disk 41, diametrically opposite one another, to hold a headless screw 441.

The threaded sleeve 5 is configured essentially as a hollow cylinder and has an inside polygon 52 into which the outside polygon 38 of the spindle 3 projects in the assembled position. On the outside, the threaded sleeve 5 is provided with two outside threads 53 and 54, which are spaced apart from one another and configured to run in opposite directions. The threaded sleeve 5 is screwed into the pressure piece 51 by way of the first outside thread 53, which piece is provided with an inside thread for this purpose. On the outside, the pressure piece 51 has an outside polygon on its side that faces away from the spindle 3, with which polygon it is guided in the inside polygon section 13 of the head piece, so as to move axially in a torque-proof manner. With its side that faces the spindle 3, the pressure piece 51 supports itself on the collar 363 formed by the ring-shaped depression 362 of the spindle rim 36.

The cone 6 comprises a bushing 61 that is closed off, on the bottom side, by way of a conical overload disk 62, and holds an overload bolt 63 that is pre-stressed against the overload disk 62 by way of a spiral spring 64. The cone 6 is configured essentially as a hollow cylinder. It has an outside polygon 611 at its end that faces the spindle 3, which polygon is guided in the inside polygon section 13 of the head piece 1 in a torque-proof manner. On the inside, an inside thread is introduced into the bushing 61 at the level of the outside polygon 611, by means of which thread the bushing is screwed together with the second outside thread 54 of the threaded sleeve 5.

The passage sleeve 7 is configured essentially as a hollow cylinder and has an axial collar 72 having an outside thread, at its end facing the spindle 3, with which thread it is screwed into the inside thread 17 of the head piece 1.

Subsequent to the outside thread, the passage sleeve 7 has a circumferential radial collar, on the inside, which collar forms a stop for the carriage 8. First windows 73 for passage of water are provided in the passage sleeve 7, which windows are cut into the sleeve wall, in the same plane, distributed symmetrically. In the exemplary embodiment, three first windows 73 are provided. The first windows 73 are provided for cold water to pass through. Axially at a distance from the first windows 73, second windows 74 are provided for hot water to pass through, which windows have essentially the same cross-section as the first windows 73 and are configured comparably to them. The windows 73, 74 are covered up, in each instance, by way of a screen mantle mesh 75, in order to prevent penetration of dirt particles. On the end side, an inside thread is provided on the passage sleeve 7, on the inside, by way of which thread it is screwed together with the bottom piece 71.

The carriage 8 is configured essentially as a hollow cylinder and arranged in the region of the windows 73 and 74 of the passage sleeve 7. In the bottom piece 71, a flow disk is provided, against which a helical spring 81 lies, which spring is pre-stressed against the carriage 8. The carriage 8 holds the thermal element 9, which is sealed off relative to the carriage 8 by way of O-rings.

The thermostat mixing valve is firmly inserted, in the assembled state, into a fitting-not shown. A rotation of the spindle 3 by way of the connection section 31, by means of a rotating handle-not shown-leads to a rotational movement of the threaded sleeve 5, on the basis of the meshing polygons 38, 52 of the spindle 3 and the threaded sleeve 5. The rotational movement of the threaded sleeve 5 leads, on the one hand, to an axial movement of the threaded sleeve 5 itself, due to the torque-proof placement of the pressure piece 51, as well as to an axial movement of the cone 6, due to the torque-proof placement of the cone 6 in the head piece 1, by means of the combination of the polygons 13, 611 of the head piece 1 and the cone 6. Such an axial movement: of the cone 6 brings about a displacement of the carriage 8, which holds the thermal element 9, by way of the contact of the overload bolt 63 with the setting piston 91 of the thermal element 9, and thereby the desired mixing position of the carriage 8 between the windows 73 (cold-water pass-through) and 74 (hot-water pass-through) is achieved. In this regard, the carriage 8 is moved counter to the spring tension of the helical spring 81. The cold and hot water that flows in through the windows 73, 74 bathes the thermal element 9, which takes on regulation of the desired temperature by way of the setting piston 91.

When the spindle 3 is rotated within the spindle guide 2, the teeth of the gear mechanism 341 are moved along the cylindrical bodies 26 that are pre-stressed against the elongated hole bores 25 of the cylindrical holder 21, by way of the annular spring 27, and thereby haptically appealing rotational operation is achieved. When the notches 342 move past the cylindrical bodies 26, these bodies slide into the notches 342 due to the pre-stress of the annular spring 27, and thereby the rotational movement of the spindle 3 is inhibited. The notches 342, in interplay with the cylindrical bodies 26 that are pre-stressed against the spindle 3 by way of the annular spring 27, form a scald protection-which cannot be seen from the outside. If a higher water temperature is desired, the spindle 3 can be rotated further by means of a significantly greater torque, something that is necessary so as to move the cylindrical bodies 26 out of the notches 342, counter to the pre-stress of the annular spring 27. For a better overview, the significant components of the scald protection of the thermostat mixing valve are shown in FIG. 2.

The torque-proof fastening of the spindle guide 2 takes place by means of the holding ring 4. The guide section 22 of the cylindrical holder 21 is inserted, with its outside hexagon 23, into the indentations 432 of the disk 41 of the holding ring 4, and thereby the cylindrical holder 21 is connected to the holding ring 4 in a torque-proof manner. The holding ring 4 is set onto the head piece 1, wherein the connection section 31 of the spindle 3 is passed through the step bore 43. In this regard, the engagement projection 421 of the holding ring 4 engages behind the circumferential engagement ridge 14 of the head piece 1, and thereby the holding ring is axially fixed in place on the head piece 1. By means of tightening the headless screws 441 that are screwed into the threaded bores 44, these screws are pressed against the head piece 1 on the end face, and thereby the engagement projection 421 is pressed against the engagement ridge 14. As a result, a force-fit, torque-proof connection between the holding ring 4 and the head piece 1 is brought about.

For setting the limit temperature, at which the scald protection described above is supposed to act, the headless screws 441 can be released, and thereby the force fit between the engagement projection 421 of the holding ring and the engagement ridge 14 of the head piece 1 is cancelled out. The holding ring 1 is thereby axially fixed in place on the head piece, but arranged so as to rotate. By means of rotating the holding ring 4 on the head piece 1, the rotational position, within the head piece 1, of the cylindrical holder 21 of the spindle guide 2, which holder is connected to the holding ring 4 in a torque-proof manner, and thereby the rotational position of the spindle 3, in which position the cylindrical bodies 26 engage into the notches 342, can be set. When the desired position has been reached—and thereby the desired limit temperature has been set—the holding ring 4 is once again connected to the head piece 1 in a force-fit and torque-proof manner, by means of tightening the headless screws 441.

In the exemplary embodiment according to FIG. 8, the holding ring 4′ has a central bore 47, and the flange 42′ is provided with an inside thread 422, by way of which it can be screwed onto an outside thread 19 that is arranged on the head piece 1′ for this purpose. A fixation ring 46, configured in the form of a disk 461 that has a circumferential collar 462, lies against the holding ring 4′. The disk 461 of the fixation ring 46 has a step bore 43 in the center, the diameter-widened section 431 of which bore, facing the flange 42, is circumferentially provided with indentations 432, into which the outside hexagon 23 of the guide section 22 of the cylindrical holder 21 provided engages, and thereby the fixation ring 46 is connected to the cylindrical holder 21 with shape fit.

The fixation ring 46, with its collar 462, lies on a ledge 10 arranged in the head piece 1′ for this purpose, on the inside, above the groove 11. To set the limit temperature, the holding ring 4′ can be released, so that the fixation ring 46 is held axially but can be rotated in the head piece 1′. By means of a rotation of the fixation ring 46, a rotation of the cylindrical holder 21 of the spindle guide 2, within the head piece 1′, which holder is connected to the ring with shape fit, can take place. When the cylindrical bodies 26 are engaged into the notches 342, the cylindrical holder 21 can be rotated, using the fixation ring 46 connected to the holder with shape fit, by way of the spindle 3. As a result, setting of the rotational position of the spindle 3 takes place, in which position the cylindrical bodies 26 are engaged into the notches 342. Subsequently, the holding ring 4′ is screwed tightly in place on the head piece 1′. As a result, the fixation ring 46 is pressed against the ledge 10 with its collar 462, and thereby the fixation ring 46, and via it, also the cylindrical holder 21, is/are connected to the head piece 1′ in a force-fit and torque-proof manner.

The placement, according to the invention, of the spindle guide 2 that holds a spindle 3, in a head piece 1 having a one-piece or two-piece holding ring 4, 4′, 46 to implement scald protection, is not restricted to use in the case of thermostat mixing valves. For example, it is also possible to use this arrangement in the case of a flow valve as described in DE 32 07 895 C2 , for example. For this purpose, it would only be necessary to arrange a driver on the spindle, on the end side, for engagement into the control disk that lies against the inlet disk. In the case of such a flow valve, it would then be possible to allow the cylindrical body to engage into the notch 342 when a defined water volume stream is reached. An increase of the water volume stream beyond this defined limit value would only be made possible with an intentional, significant increase in the torque at the spindle. Unintentional setting of an overly high water volume stream would be prevented in this way. Likewise, this arrangement according to the invention could also be used in the case of a mixing valve without a thermostat, as it is described, for example, in DE 20 2005 003 127 U1 . Here, the engagement of the cylindrical body into the notch establishes a limit temperature in the form of a fixed mixing ratio of hot and cold inflow water. In contrast to a thermostat valve, however, this limit temperature can vary as a function of the actual water inflow temperatures (hot water/cold water).

1. An upper valve part for a sanitary fitting, in particular a shower fitting or tub fitting, having a head piece (1) through which a spindle (3) passes, wherein the spindle is arranged to rotate in the head piece (1) but is axially fixed in place, and wherein the spindle is connected to a valve element that is controllable by way of the spindle (3), wherein means for limiting the maximum rotation angle of the spindle (3), in manner that can be overcome, are provided, wherein the means comprise at least one resiliently mounted locking element that engages into a recess arranged in the spindle (3) or in the head piece, in a defined rotational position of the spindle (3).

2. The upper valve part according to claim 1, wherein an annular spring (27) is arranged to surround the spindle (3), by way of which spring the at least one locking element is mounted to be resiliently pre-stressed against the spindle (3), wherein the spindle (3) has at least one recess for engagement of a locking element in a specific rotational position.

3. The upper valve part according to claim 2, wherein the at least one locking element is formed by a cylindrical body (26) that is preferably mounted so as to rotate, wherein the at least one recess is a notch (342) introduced into the spindle (3).

4. The upper valve part according to claim 2, wherein the at least one locking element is guided in a cylindrical holder (21), wherein the spindle (3) passes through the cylindrical holder (21) so as to rotate, and wherein the cylindrical holder (21) is enclosed by the annular spring (27), wherein locking means are provided, by way of which the cylindrical holder (21) can be fixed in place in the head piece (1), in a desired rotational position.

5. The upper valve part according to claim 4, wherein the locking means can be operated from the end face of the head piece (1).

6. The upper valve part according to claim 5, wherein the locking means comprise a holding ring (4, 46) that is connected to the cylindrical holder (21) in a torque-proof manner.

7. The upper valve part according to claim 6, wherein the cylindrical holder (21) has a non-round outside contour that engages into, and is connected to in a shape-fit manner, a corresponding non-round inside contour of the holding ring (4, 46).

8. The upper valve part according to claim 6, wherein the locking means comprise engagement means that engage around the head piece (1) for locking the holding ring (46) in place, wherein preferably screw means are provided, for bracing the engagement means relative to one another.

9. The upper valve part according to claim 8, wherein the engagement means comprise an engagement ridge (14) that is present on the head piece and surrounds it the head piece at least in certain regions, as well as an engagement projection (421) that is present on the holding ring (4) and surrounds the holding ring (4) radially, at least in certain regions, wherein the screw means are preferably formed by at least one screw introduced into a threaded bore of the holding ring wherein the at least one screw can is braceable against the head piece (1) at a right angle to the engagement ridge (14).

10. The upper valve part according to claim 8, wherein the locking means comprise an inside thread, by way of which the holding ring (4′) can be screwed onto an outside thread (19) that is present on the head piece (1′), wherein a fixation ring (46) that lies against the holding ring (4′) lies against a ledge (10) arranged in the head piece (1′).

11. The upper valve part according to one of claim 2, wherein the spindle is provided with a gear mechanism, radially on its a circumference of the spindle, wherein the gear mechanism is interrupted by the at least one recess.

12. The upper valve part according to claim 1, wherein the upper valve part is configured as a thermostat mixing valve, wherein the valve element is a setting element that is axially displaceable by means of rotation of the spindle.

13. The upper valve part according to claim 1, wherein the upper valve part is configured as a flow valve, wherein the valve element is a control disk that can be rotated, by way of the spindle, relative to an inlet disk that is arranged fixed in place.
